(19) United States
(12) Patent Application Publication
(10) Pub. No.: US 2005/0207941 A1
(43) Pub. Date: Sep. 22, 2005

(54) Dissolution sample transfer device and method

(76) Inventors: Luke Lee, Belle Mead, NJ (US); Hok Teck Chuo, Bridgewater, NJ (US)

Correspondence Address: BRIAN ROFFE, ESQ, 11 SUNRISE PLAZA, SUITE 303, VALLEY STREAM, NY, 11580-6170, US

(21) Appl. No.: 11/071,566

(22) Filed: Mar. 3, 2005

Related U.S. Application Data
(60) Provisional application No. 60/549,954, filed on Mar. 4, 2004.

(51) Int. Cl. B32B 27/04; B32B 5/02; B32B 27/12

(52) U.S. Cl. 422/82

(57) ABSTRACT

Dissolution sample transfer device for transferring dissolution samples from dissolution vessels to vials including a transfer module housing, a rack defining receptacles receivable of vials, a delivery head arranged in connection with the housing and movable relative to the rack, needles mounted on the delivery head and defining a flow passage to a tip thereof, and a conduit system arranged in connection with the housing for providing conduits for flow of dissolution samples from dissolution vessels to the needles. The needles are movable upon movement of the delivery head to position the tips of the needles to condition filters and wash sample lines or immediately above or in vials when received in the receptacles in the rack. It is possible to automatically transfer the dissolution samples from dissolution vessels to vials which can be handled by a sample arm of an analysis device, e.g., grasped directly from the rack.

### CROSS REFERENCE TO RELATED APPLICATION

This application claims priority under 35 U.S.C. §119(e) of U.S. provisional patent application Ser. No. 60/549,954 filed Mar. 4, 2004, the specification of which is incorporated by reference herein.

### FIELD OF THE INVENTION

The present invention relates to a dissolution sample transfer device which is capable of transferring dissolution samples to an HPLC or to another analysis device.

The present invention also relates to a method for transferring dissolution samples from dissolution vessels to vials which can be manipulated and analyzed by an analysis device.

### BACKGROUND OF THE INVENTION

Tablet dissolution testing is a standard operation for pharmaceutical companies, as per regulations, a minimum of 6 tablets are to be tested at the same dissolution tester. The dissolution samples must be withdrawn from the dissolution vessels at different time intervals and sent for analysis by an HPLC or UV or another analysis system to obtain data about the dissolution of the tablets for use in, for example, calculating the percentage dissolution of the tablets.

Normally, dissolution testers are operated by one person who is responsible for placing the tablets into the dissolution vessels at a designated start time to and withdrawing the samples at predetermined time intervals. All the withdrawn samples are manually placed in sample tubes, manually filtered and then put into HPLC vials for the HPLC injection or subjected to another preparation for different analysis methods.

When performing dissolution testing in the above manner, it is a significant problem for the operator to manually withdraw the samples at the different time intervals because there typically are at least 6 samples to be withdrawn in a very short period time. To transfer the samples into the HPLC vials is another problem as it is time-consuming and mistakes can be made by the operator. Indeed, if the samples are put in the wrong order in the HPLC sample rack, the end data relating to the tablet dissolution will be inaccurate.

### OBJECTS AND SUMMARY OF THE INVENTION

It is an object of the present invention to provide a new and improved dissolution sample transfer device.

It is another object of the present invention to provide a new and improved automated dissolution sample transfer device in which manual sampling prevalent in prior art dissolution sample transfer devices has been automated to simplify the dissolution sampling and avoid mistakes in the transfer of the dissolution samples.

It is still another object of the present invention to provide a new and improved automated method for transferring dissolution samples from dissolution vessels to vials which can be manipulated and analyzed by an analysis device.

In order to achieve these objects and others, a dissolution sample transfer device for transferring dissolution samples from dissolution vessels to vials in accordance with the invention includes a transfer module housing, a rack defining a plurality of receptacles with drainage holes and receivable of vials, a movable delivery head arranged in connection with the housing and being movable relative to the rack, needles mounted on the delivery head and defining a flow passage to a tip thereof, and a conduit system arranged in connection with the housing for providing a plurality of conduits for flow of dissolution samples from dissolution vessels to the needles. The needles are movable upon movement of the delivery head such that the tips of the needles are positionable immediately above or in vials when the vials are received in the receptacles in the rack. With this construction, it becomes possible to automatically wash the conduits, drain the washing liquid and then transfer the dissolution samples from the dissolution vessels to the vials through the previously washed conduits. Once in the vials, the dissolution samples can be handled by a sample arm of an analysis device, e.g., grasped directly from the rack.

The conduit system may include a plurality of filter members, each having an inlet and an outlet fitting, defining a flow path between the inlet and the outlet fitting and filtering material arranged in the flow path. A respective tube connects the outlet fitting to a respective needle. Tubing systems are attached at one end to a respective filter member and receive a dissolution sample from a dissolution vessel at an opposite end, either directly when a single tube constitutes the tubing system or from a pump which has a tube leading to the dissolution sample. The pump connects to the tubing systems to enable flow of the dissolution samples from the dissolution vessels to the filter members and through the filter members to the needles. A delivery head raises and lowers the needles to deliver the samples into vials.

To move the delivery head relative to the rack and thereby enable the placement of the vials into the rack and removal of vials from the rack, vertical rods extend between the rack and a portion of the housing and a screw extends upward from the delivery head. The screw is movable vertically upon rotation of an actuating device in the housing.

The method for transferring dissolution samples from dissolution vessels to vials involves the following steps, not necessarily in the listed order. Arranging a movable delivery head above a rack with receptacles with drainage holes, drawing dissolution samples from dissolution vessels to flow through filters to condition them, to wash the sample lines and drain waste liquid, arranging a movable delivery head above a rack defining a plurality of receptacles receivable of vials, moving the delivery head away from the rack to enable vials to be placed into the receptacles in the rack, mounting needles on the delivery head each defining a flow passage to a tip thereof, placing vials in the receptacles in the rack and then moving the delivery head and thus the needles until the tips of the needles are positioned immediately above or in the vials, arranging filter members on the delivery head, connecting tubes between outlets of the filter members and the needles, and directing dissolution samples from the dissolution vessels to the filter members and through the filter members to the needles and through the needles into the vials.

In one embodiment, a pump is arranged in the flow path of the dissolution samples between the dissolution vessels and the filter members to transfer a predetermined amount of dissolution sample from the dissolution vessel to condition the filter members and wash the tubes. The waste liquid thus generated is deposited into specified receptacles in the rack and removed from the rack via a drainage system.

Other and further objects, advantages and features of the present invention will be understood by reference to the following specification in conjunction with the annexed drawings.

### BRIEF DESCRIPTION OF THE DRAWINGS

The invention, together with further objects and advantages thereof, may best be understood by reference to the following description taken in conjunction with the accompanying drawings wherein like reference numerals identify like elements.

FIG. 1 is a front perspective view of the dissolution sample transfer device in accordance with the invention shown when used in combination with a dissolution tester.

FIG. 2 is a schematic showing one manner in which the dissolution sample transfer device can be used in a method for transferring dissolution samples from dissolution vessels to vials suitable for analysis by an analyzing device.

### DETAILED DESCRIPTION OF THE INVENTION

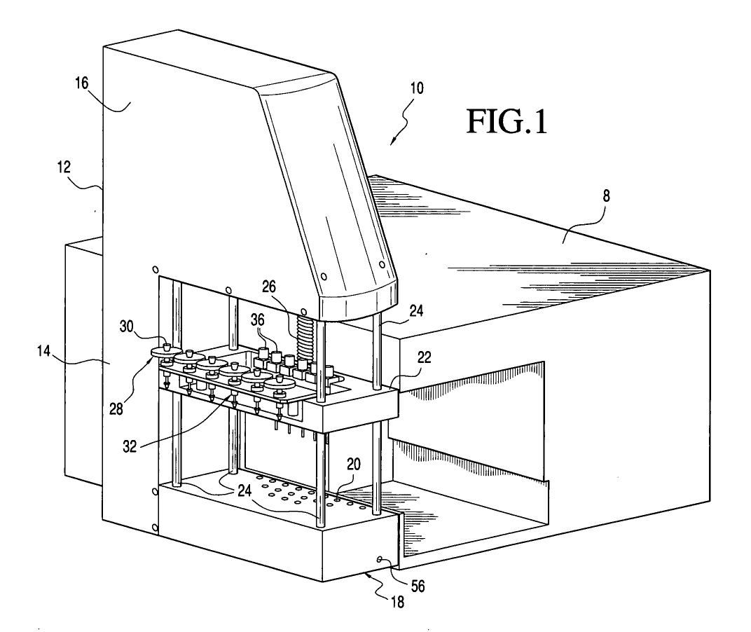

Referring to the accompanying drawings, FIG. 1 shows a dissolution sample transfer device in accordance with the invention which is designated generally as 10 and comprises a transfer module housing 12 having a vertical portion 14 and an overhead portion 16, a rack 18 defining a plurality of receptacles 20, a delivery head 22 and vertical rods 24 extending between the rack 18 and the overhead portion 16 of the housing 12.

In the rack 18, the receptacles 20 are dimensioned to accommodate any standard size vials, preferably vials suitable to be handled by an analyzing device 8 arranged alongside the transfer device 10. Also, as shown, there are three rows of receptacles 20, three in a first row, six in a second, middle row and nine in a third, last row. When six tablets are being tested, vials would be placed in the middle row. The number of rows and receptacles therein can be varied as desired, depending on the use of the transfer device 10. The rack 18 also includes a drain hole 56 communicating with each of the receptacles 20 for draining the washing liquids that flow through before or after the transfer of the dissolution samples into the vials. Alternatively, several drain holes can be provided and each receptacle 20 associated with one or more of the drain holes.

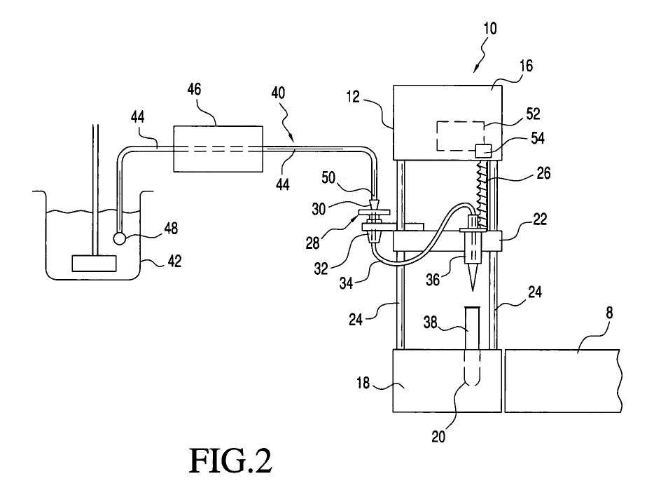

A movement mechanism is provided for moving the delivery head 22 vertically along the rods 24 and may comprise a screw 26 arranged to extend upward from the delivery head 22 and an actuating device 54 (see FIG. 2) in the overhead portion 16 of the housing 12 through which the screw 26 passes. The actuating device 54 is rotated by, for example, a motor 52, and causes the screw 26 to move vertically along the rods 24. Depending on the direction of rotation of the actuating device, the screw 26 and delivery head 22 either move upward or downward. Other mechanisms for moving the delivery head 22 vertically along the rods 24 are also envisioned within the scope and spirit of the invention.

The delivery head 22 also includes six filter members 28, each having an inlet 30 on an upper side, and an outlet fitting 32 on a lower side to which a respective tube 34 is connected (see FIG. 2). Tube 34 is also referred to as a sample delivery line. The filter member 28 includes filtering material for filtering the dissolution sample in its flow through the filter member 28 from the inlet 30 to the outlet fitting 32. The other end of the tubes 34 is connected to one of a plurality of needles 36 mounted on the delivery head 22, each tube 34 leading from one of the outlet fittings 32 to a respective needle 36. An automated filter changer to replace, insert or otherwise change filter members 28 is also envisioned within the scope and spirit of the invention. The number of filter members 28 may be varied depending, for example, on the number of receptacles 20 in the rows in the rack 18.

Each needle 36 provides a flow conduit for the dissolution sample from the inlet thereof to which the tube 34 is connected to an outlet defined at a tip of the needle 36 and which is situated in or immediately above the vial 38 (in a position to ensure that the flow of dissolution sample from the tip enters into the vial 38). The positioning of the needles 36 to be situated with the tip thereof in the vials 38 is achieved by the vertical movement of the delivery head 22 under the control of a processor or other control unit. Vials 38 may be any suitable vials, such as HPLC vials.

Referring again to FIG. 2, the transfer device 10 also includes a plurality of tubing systems 40 through which dissolution samples from dissolution vessels 42 are transferred to the vials 38 placed in the receptacles 20 in the rack 18, each dissolution sample into a respective vial 38 and such that the labeling order of the dissolution samples in the vials 38 is the same labeling order (1 through 6) as the dissolution vessels 42. Each tubing system 40 includes one or more tubes 44, depending on the type of pump 46 used to pump the dissolution samples from the dissolution vessels 42 to the filter members 28. If the pump 44 is a multi-channel peristaltic pump, the tubing system 40 consists of a single tube which has an inlet end 48 situated in the dissolution vessel 42 and an outlet end 50 connected to the inlet 30 of the filter member 28. If the pump 44 is a multi-channel syringes pump, the tubing system includes two tubes, one of which leads from the dissolution vessel 42 to the pump 44 and the other of which leads from the pump to the inlet 30 of the filter member 28. Regardless of which pump 44 is used, each dissolution sample is independently pumped through a respective tubing system 40 from one of the dissolution vessels 42 to the respective vial 38. Any automated filter changer used with the system would insert and remove filter members 28 between outlet end 50 and the tubes 34.

A processor or control system (PC and software) controls the timing and motion of the transfer device 10. For example, the processor and software would control the transfer of the dissolution samples from the dissolution vessels 42 to the vials 38 at every time interval and ensure that the needles 36 mounted on the delivery head 22 are automatically lowered into the vials 38 to delivery the samples.

As shown in FIG. 1, the transfer device 10 is designed for use immediately adjacent to a sample analysis device 8, such as the Autosampler (Agilent 1100). This analysis device 8 including a sample arm (not shown) which is capable of extending and reaching the vials 38 in the rack 18 of the transfer device 10. As such, the sample arm is able to automatically place the vials 38 in the transfer device 10 or remove the vials 38 from the transfer device 10 as needed.

In an exemplifying use, six tablets to be tested are dropped into six dissolution vessels 42 and stirred. At the sampling time interval start, the delivery head 22 will lower the needles 36 to a delivery position (without any vials 38 present) above receptacles 20. At the same time interval, the pump 46 will transfer a predetermined amount of dissolution sample from dissolution vessel 42 to condition the filter members 28 and wash the sample delivery line 34 and the needles 36. The waste liquid is deposited into the middle (second) row of 6 vial receptacles 20 and drained away via drain hole 56.

Next the delivery head 22 is raised to a sufficient height (via control of motor 52 by the processor and software) to enable six vials 38 to be placed by a moving arm in the analysis instrument 8 (e.g. Agilent 1100) in the receptacles 20 in the middle row of the rack 18. The tubes 34 are connected between the outlets 32 of the filter members 28 and the inlets of the needles 36. The tubing system 40 is connected between the inlets 30 of the filter members 28 and the dissolution samples in the dissolution vessels 42 and passed through the pump 46. To prepare for the transfer of the dissolution samples into the vials 38, the processor lowers the delivery head 22 until the tips of the needles 36 are position in or immediately above the vials 38 or have pierced vial septa. The pump 44 is started to cause the flow of dissolution sample from the dissolution vessels 42 to the vials 38 via the tubing system 40 and filter members 28. When sufficient dissolution sample is present in the vials 38, the pump 44 is stopped, the delivery head 22 is raised to enable the arm of the analysis device 8 to grasp the vials 38 and proceed to analyze the dissolution samples therein. Alternatively, the vials 38 can be moved by the arm from the rack 18 of the transfer device to a sample tray of the analysis device 8.

With the transfer device and control system described above, it becomes possible to transfer dissolution samples from the dissolution vessels 42 to a sample tray of the analysis device 8, automatically perform an HPLC injection and obtain the area/height results from the data acquisition system to calculate the percent dissolved rate of the tablets. Dissolution sampling is significantly simpler than in the prior art which require a lab technician to appropriately fill the vials. Also, in view of the automation, mistakes in the transfer of the dissolution samples are avoided.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A dissolution sample transfer device for transferring dissolution samples from dissolution vessels to vials, comprising:
a transfer module housing;
a rack defining a plurality of receptacles receivable of vials;
a movable delivery head arranged in connection with said housing, said delivery head being movable relative to said rack;
needles mounted on said delivery head and defining a flow passage to a tip thereof, said needles being movable upon movement of said delivery head such that the tips of said needles are positionable immediately above or in vials when vials received in said receptacles in said rack; and
conduit means arranged in connection with said housing for providing a plurality of conduits for flow of dissolution samples from dissolution vessels to said needles.

2. The device of claim 1, wherein said conduit means comprise a plurality of filter members, each having an inlet and an outlet fitting, defining a flow path between said inlet and, said outlet fittings and filtering material arranged in said flow path, and a respective tube connected to said outlet fitting and to a respective one of said needles.

3. The device of claim 2, wherein said filter members are replaceable by an automated filter changer to insert, replace or discard said filter members.

4. The device of claim 2, wherein said conduit means further comprise a plurality of tubing systems, each attached at one end to a respective one of said filter members and being arranged to receive a dissolution sample from a dissolution vessel at an opposite end, and a pump connectable to said tubing systems to enable flow of the dissolution samples from the dissolution vessels to said filter members and through said filter members to said needles.

5. The device of claim 1, further comprising movement means for moving said delivery head relative to said rack.

6. The device of claim 5, wherein said movement means comprise vertical rods extending between said rack and a portion of said housing and a screw extending upward from said delivery head, said screw being movable vertically upon rotation of an actuating device in said housing.

7. The device of claim 1, further comprising a drainage system built into said rack in communication with said receptacles to enable disposal of waste from said receptacles.

8. The device of claim 1, wherein said rack further includes at least one additional receptacle position for a reader for sample identification and at least one additional receptacle position for discarding sample vials.

9. A method for transferring dissolution samples from dissolution vessels to vials, comprising the steps of:
arranging a movable delivery head above a rack defining a plurality of receptacles receivable of vials;
moving the delivery head away from the rack to enable vials to be placed into the receptacles in the rack;
mounting needles on the delivery head, each needle defining a flow passage to a tip thereof; placing vials in the receptacles in the rack and then moving the delivery head and thus the needles until the tips of the needles are positioned immediately above or in the vials;
arranging filter members on the delivery head;
connecting tubes between outlets of the filter members and the needles; and
directing dissolution samples from the dissolution vessels to the filter members and through the filter members to the needles and through the needles into the vials.

10. The method of claim 9, wherein the step of directing dissolution samples from the dissolution vessels to the filter members comprises connecting tubes having inlets situated in the dissolution vessel to inlets of the filter members.

11. The method of claim 10, wherein the step of directing dissolution samples from the dissolution vessels to the filter members further comprises arranging a pump in connection with the tubes.

12. The method of claim 9, further comprising the steps of:
arranging a pump in the flow path of the dissolution samples between the dissolution vessels and the filter members to transfer a predetermined amount of dissolution sample from the dissolution vessel to condition the filter members and wash the tubes;
depositing the waste liquid thus generated into specified receptacles in the rack; and
removing the waste liquid from the receptacles via a drainage system.
